(19) United States
(12) Patent Application Publication
(10) Pub. No.: US 2024/0387831 A1
(43) Pub. Date: Nov. 21, 2024

(54) MULTI-LAYER CURRENT COLLECTORS FOR ANODELESS LITHIUM-METAL CELLS

(71) Applicant: THE REGENTS OF THE UNIVERSITY OF COLORADO, A BODY CORPORATE, Denver, CO (US)

(72) Inventors: Se-Hee LEE, Denver, CO (US); Nathan DUNLAP, Denver, CO (US)

(21) Appl. No.: 18/696,128

(22) PCT Filed: Sep. 16, 2022
(86) PCT No.: PCT/US22/43870

§ 371 Date: Mar. 27, 2024

Related U.S. Application Data
(60) Provisional application No. 63/249,274, filed on Sep. 28, 2021.

(51) Int. Cl. H01M 4/66; H01M 4/04; H01M 4/62; H01M 10/052

(52) U.S. Cl. CPC H01M 4/667; H01M 4/0445; H01M 4/628; H01M 4/662; H01M 10/052

(57) ABSTRACT

A multi-layer current collector for an anodeless lithium-metal cells is described. The multi-layer current collector includes a current collector layer, a seed layer disposed on the current collector layer, and a protective shield layer disposed on the current collector layer. When incorporated into a Li-metal cell along with an electrolyte, charging of the cell leads to Li ion transferring through the shield layer, saturating the seed layer and ultimately forming a new Li metal layer between the shield layer and the lithiated seed layer. Discharging the cell reverses this process and results in disappearance of the Li metal layer and lithium passes back through the shield layer and into the electrolyte. The lithium in the seed layer also passes back into the electrolyte such that the current collector reverts to its initial structure prior to charging.

### CROSS-REFERENCE TO RELATED APPLICATION(S)

This application claims the benefit of priority to U.S. Provisional Patent Application No. 63/249,274, entitled “Multi-Layer Current Collectors for Anodeless Lithium-Metal Cells”, filed Sep. 28, 2021, the entirety of which is hereby incorporated by reference.

### TECHNICAL FIELD

The present disclosure relates to multi-layer current collectors for anodeless lithium-metal cells, and more specifically, a multi-layer current collector including a current collector layer, a seed layer disposed on the current collector layer, and a protective shield layer disposed on the current collector layer.

### BACKGROUND

Due to its large theoretical capacity (3,860 mAh g⁻¹) and low electrochemical potential (−3.04 V vs. SHE), lithium is widely considered an ideal anode material for the next generation of high energy density, high power batteries. However, because of its soft nature and reactivity, manufacturing thin lithium metal anodes and fabricating large format cells poses a significant engineering challenge.

To avoid these issues, researchers have proposed the development of anode-free or “anodeless” cell designs in which lithium is plated directly onto a current collector in situ during charging. Because the cathode acts as the sole source of lithium in an anodeless cell, there is no longer a need to prepare or process costly lithium foils. Furthermore, the volumetric and gravimetric energy density of anodeless cells is greatly improved by removing all excess lithium.

However, practically realizing the anodeless concept has been challenging. This is largely due to the difficulty of controlling the morphology of the lithium deposits and mitigating any interfacial reactions with the cell's electrolyte. When plated directly onto a current collector, lithium tends to form mossy, dendritic structures. These low-density deposits can lead to short circuiting of the cell and irreversible capacity loss through the formation of isolated “dead” lithium. Furthermore, the large surface area of these mossy structures leads to the continued formation of thick solid electrolyte interphase (SEI) layers with cycling. This increases the resistance of the cell while depleting its limited supply of lithium.

Accordingly, a need exists for improved anodeless cell design that addresses some or all of the issues described previously.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, an anodeless Li-metal cell is described, the cell comprising a multi-layer current collector and an electrolyte. The multilayer current collector may comprise a current collector layer, a lithium-alloying or lithium-soluble seed layer disposed on the current collector layer, and a lithium ion-conductive protective layer disposed on the seed layer. The electrolyte may be shielded from the current collector layer and the seed layer by the protective layer, and may be an organic electrolyte, an ionic liquid electrolyte, or a solid-state electrolyte.

In some embodiments, a method of cycling a Li-metal cell is described, wherein the method includes the steps of providing a Li-metal cell and charging the cell. The Li-metal cell provided in a first step includes a multi-layer current collector and an electrolyte, with the multi-layer current collector including a current collector layer, a lithium-alloying or lithium-soluble seed layer disposed on the current collector layer, and a lithium ion-conductive protective layer disposed on the seed layer. The electrolyte is shielded from the seed layer and the current collector layer by the protective layer. Charging the cell in a second step results in lithiating the seed layer; and forming a lithium metal layer between the lithiated seed layer and the protective layer. The method can further include a step of discharging the cell, which results in delithiating the seed layer and
removing the lithium metal layer such that the protective layer is disposed on the seed layer.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is an illustration of a multi-layer current collector suitable for use in an anodeless lithium-metal cell according to various embodiments described herein.

FIG. 2 is an illustration of linear polyacrylonitrile, cyclized polyacrylonitrile, and thermal stabilization of closely packed polyacrylonitrile chains.

FIG. 3 is voltage profiles of various Li-metal half-cells during their first charge.

FIG. 4 is optical microscope images of a multi-layer current collector cross sectioned after its first charge (13 mAh) in a coin cell (liquid electrolyte).

FIG. 5 is focused ion beam (FIB) scanning electron microscope (SEM) images of a fully charged multi-layer all-solid-state anodeless cell after extended cycling.

FIG. 6 is graphs showing cycling stability and coulombic efficiency of all-solid-state anodeless full cells prepared with a stainless steel or multi-layer current collector.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

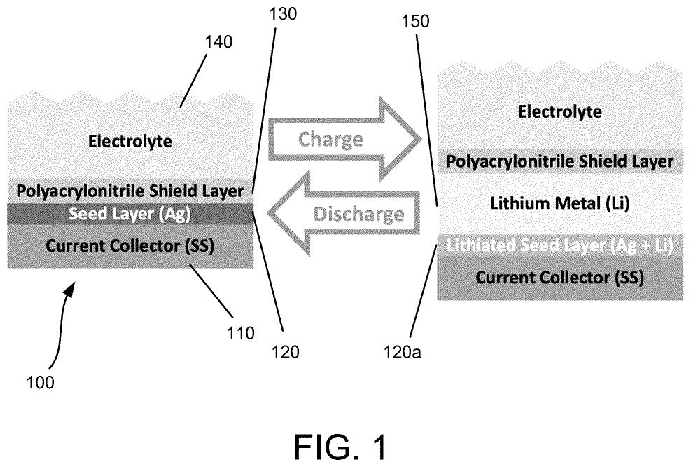

With reference to FIG. 1, a multi-layer current collector 100 suitable for use in an anodeless Li-metal cell generally includes a current collector layer 110, a seed layer 120, and a shield layer 130. FIG. 1 further shows an electrolyte 140 that can be used with the multi-layer current collector 100 as part of forming the anodeless Li-metal cell. FIG. 1 further shows the change that occurs in the multi-layer current collector 100 as the anodeless Li-metal cell incorporating the multi-layer current collector 100 is charged and discharged. More specifically, charging the anodeless-Li-metal cell results in the seed layer 120 becoming lithiated seed layer 120a, as well as the formation of lithium metal layer 150 between lithiated seed layer 120a and shield layer 130. The mechanism behind the change in structure of the multi-layer current collector 100 is described in greater detail below following further discussion of the structure of the initial multi-layer current collector 110.

The current collector layer 110 of the multi-layer current collector 100 generally serves as the first layer of the multi-layer current collector 100, i.e., the layer furthest away from the interface between the multi-layer current collector 100 and the electrolyte 140 and upon which other layers of the multi-layer current collector 100 are disposed. The current collector layer 110 is made from a highly electronically conductive material that also shows little to no reactivity with lithium. Any material meeting these requirements can generally be used. In some embodiments, the current collector layer 110 is provided in the form of a relatively thin metal foil layer, such as a metal foil layer having a thickness in the range of about 10 μm. One exemplary material suitable for use as the material of the current collector layer 110 is stainless steel (e.g., 10 μm thick stainless steel foil), though other materials, such as, but not limited to Ni, Cu, etc., can also be used. The current collector layer can also include any combination of any of the previously mentioned materials provided the current collector layer maintains its properties of being highly electronically conductive with little to no reactivity with lithium. Additional materials not expressly mentioned herein may also be included in the current collector layer 110, provided the presence of these additional materials does not substantially negatively impact the electronically conductive and little to no reactivity with lithium characteristics of the current collector layer 110.

With continuing reference to FIG. 1, the second layer of the multi-layer current collector 100, i.e., the layer disposed on the current collector layer 110, is the seed layer 120. The seed layer 120 is composed of an Li-alloying or Li-soluble material. Exemplary, though non-limiting, materials that can be used in the seed layer 120 include Ag, Sn, In, Al, Ge, Bi, etc. Any other materials that are Li-alloying or Li-soluble can also be used. The seed layer may also include any combination of these materials provided that the seed layer remains Li-alloying or Li-soluble. Other materials may also be included in the seed layer 120, provided they do not substantially impede the Li-alloying or Li-soluble nature of the seed layer 120.

The seed layer 120 serves to reduce the lithium nucleation energy barrier. Seed layer 120 also encourages the formation of thick, uniform lithium deposits on top of the seed layer 120 as described in greater detail below. The thickness of seed layer 120 is preferably kept as small as possible while still maintaining good cycling performance. This balance will maximize the cell's volumetric and gravimetric capacity by ensuring that most of the lithium is plated on the seed layer 120 after the seed layer 120 is quickly saturated.

Any manner of forming the seed layer 120 on the current collector layer 110 can be used. In one non-limiting example, the seed layer 120s formed on the current collector layer 110 via a magnetron sputtering technique. Other deposition techniques (e.g., electroplating, electroless plating, etc.) can also be used provided that the techniques provide a thin, pure, uniform seed layer 120.

With continuing reference to FIG. 1, the third layer of the multi-layer current collector 100, i.e., the layer disposed on the seed layer 120, is the protective shield layer 130. This shield layer 130 is important for the long-term cycling stability of the anodeless design. The shield layer 130 acts as an artificial solid electrolyte interface (SEI) or protective barrier, separating the plated lithium metal layer 150 (described in greater detail below) from the reactive electrolyte 140 (described in greater detail below). Without the shielding layer 130, much of anodeless cell's limited lithium supply would be lost to persistent interfacial reactions.

Suitable material for the shield layer 130 includes material that will show sufficient ionic conductivity to shuttle Li-ions through to the seed layer 120 below. The material of the shield layer 130 should also have a high degree of chemical stability in order to minimize interfacial reactions with the electrolyte 140 and lithium deposits 150. Lastly, the preferred material for shield layer 130 will have robust, resilient mechanical properties. This toughness is important in avoiding cracking with cycling. Any cracks that form in the shield layer 130 will expose the fresh lithium deposits 150 to the reactive electrolyte 140. These cracks can also act as weak points for lithium dendrites to exploit and propagate through the cell.

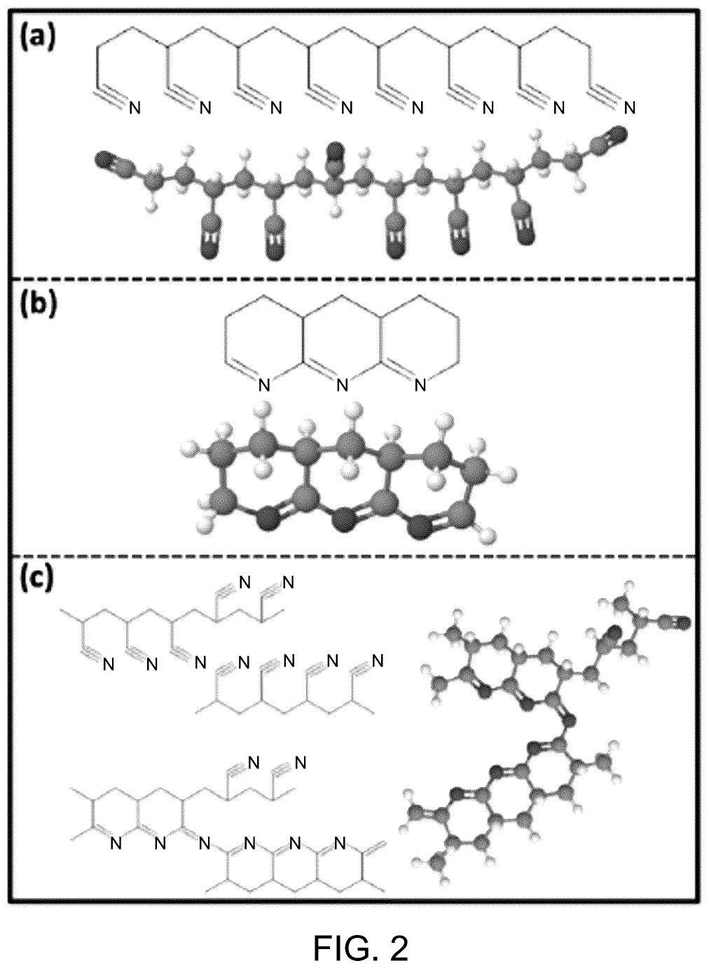

In some embodiments, a preferred material for the shield layer 130 is the mixed conducting polymer polyacrylonitrile (PAN). PAN is a unique polymer in that it is inexpensive, commercially available, and displays both good mechanical toughness and Li-ion conductivity. In its virgin state, PAN is a linear polymer characterized by its triple bonded nitrile groups (see FIG. 2). These highly electronegative nitrile groups allow PAN to be dissolved in polar solvents (e.g., dimethylformamide (DMF)). They also promote good adhesion via strong intermolecular forces. This enables precise coating of thin, robust PAN layers via simple solution blading and drying techniques compatible with modern roll-to-roll processing. Upon heat treating (e.g., 300° C. for 3 hrs), PAN's nitrile groups can cyclize to form conjugated pyridinic ladder structures and conjugated cross linkages with neighboring chains (see FIG. 2). This further strengthens the polymer mechanically while maintaining its ionic conductivity. This version of PAN is referred to herein as cyclized PAN (cPAN).

In some embodiments, a preferred material for the shield layer 130 is LiPON. LiPON is an amorphous Li₃PO₄₋ₓNₓ layer that can be deposited via reactive sputtering of Li₃PO₄ target in a nitrogen environment. LiPON is effective in preventing Li dendrite propagation through the shield layer 130 and improves cycling efficiency and stability.

When the current collector 100 is used in an anodeless Li-metal cell, the Li-metal cell further includes an electrolyte 140. As shown in FIG. 1, the electrolyte is in contact with the shield layer 130 but does not directly contact the seed layer 120 or the current collector layer 110. The electrolyte may be an organic or ionic liquid electrolyte, or a solid state electrolyte when the cell is an all-solid-state cell. Cyclized PAN as the material of the shield layer 130 is compatible with both conventional cells utilizing organic or ionic liquid electrolytes as well as all-solid-state cells that depend on solid state electrolytes.

In embodiments where the cell is a solid state cell using a solid electrolyte, one embodiment of a suitable solid state electrolyte is crystalline argyrodite (Li₆PS₅Cl), which can be provided in the form of a separator. The sulfide argyrodite electrolyte achieves a reasonable room temperature ionic conductivity (>1 mS cm⁻¹) with a Li transference number close to 1. This enables good rate capability and large cathode mass loading. Furthermore, the argyrodite has relatively soft, elastic mechanical properties. This allows intimate, conformal interfaces with the multi-layer current collector 100 to be made via simple cold-press processing techniques.

As shown in FIG. 1, charging a cell including the current collector 100 described above and an electrolyte 140 generally results in Li ions from the electrolyte passing through the shield layer 130, at which point the seed layer 120 (made of Li-soluble or Li-alloying material) takes up the Li ions to form a lithiated seed layer 120a. After the lithiated seed layer 120a becomes saturated, further Li ions passing through the shield layer 130 begin to plate the lithiated seed layer 120 and form a lithium metal layer 150 between the lithiated seed layer 120a and the shield layer 130. The lithium metal layer 150 continues to grow in thickness and more Li ion pass through the shield layer 130 during charging.

During discharging, the process is reversed, and the lithium material of the lithium metal layer 150 passes back through the shield layer 130 and into the electrolyte 140. This ultimately results in the disappearance of the lithium metal layer 150 such that the lithiated seed layer 120a is abutting the shield layer 130. At this point, lithium in the lithiated seed layer 120a begins to pass through the shield layer 130 and into the electrolyte such that the lithiated seed layer 120a reverts back to a seed layer 120. It is also possible the lithium in the lithiated seed layer 120a begins to transfer through the shield layer 130 into the electrolyte 140 prior to full disappearance of the lithium metal layer 150.

### EXAMPLES

### Example 1

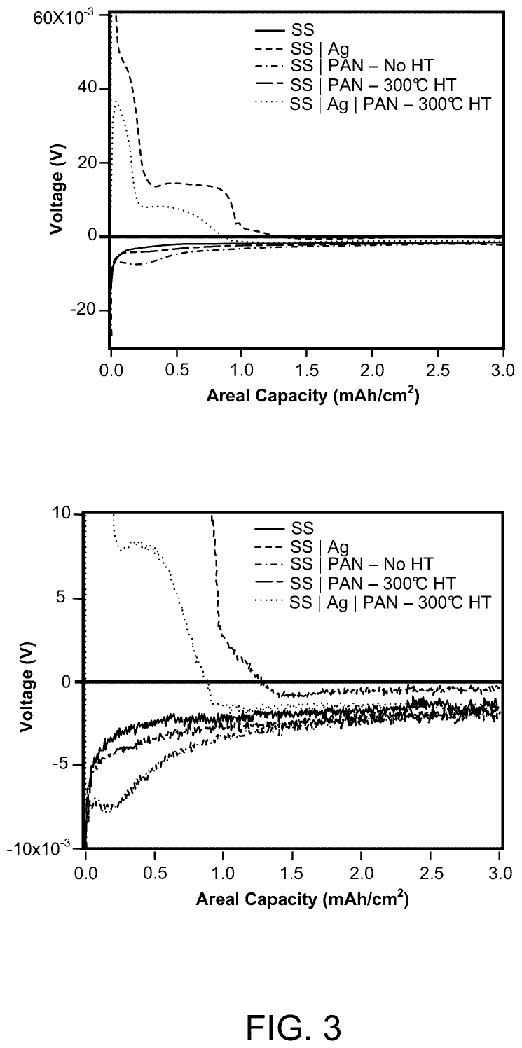

To verify the operating principles of the anodeless design described herein, we a series of all-solid-state lithium half-cells were prepared. By using a lithium counter electrode, it was possible to plate large amounts of lithium metal onto various current collectors while precisely monitoring their potentials (see FIG. 3).

In a lithium half-cell, Li plating occurs at voltages below 0 V. The cells that contained no Li-alloying seed layer (Ag) show sharp, immediate voltage drops that slowly relax with continued Li plating. Interestingly, the current collector with a pristine PAN coating shows the greatest overpotential with lithium plating while the heat treated PAN current collector shows a similar profile to the bare stainless steel (SS) foil. This suggests that the PAN layer is too resistive prior to heat treatment. The Ag-coated stainless steel current collector shows clear signs of Li-alloying at voltages greater than 0 V. After charging ˜1.25 mAh/cm² the Ag layer becomes saturated and lithium begins to plate as the cell's voltage dips below 0 V. The Ag-coated stainless steel foil then shows a much smaller Li-plating overpotential compared to the PAN coated or bare stainless steel current collectors. This indicates that the fully lithiated Ag layer helps to reduce the nucleation energy of the plated Li, which can result in more uniform, dense deposits. Most importantly, the voltage profile of the tri-layer current collector constructed in accordance with embodiments described herein shows clear evidence that the Ag seed layer below the cPAN shield layer was utilized and fully saturated. This strongly indicates that upon charging, Li-ions were able to quickly diffuse through the cPAN shield layer and alloy/plate on the seed layer below.

### Example 2

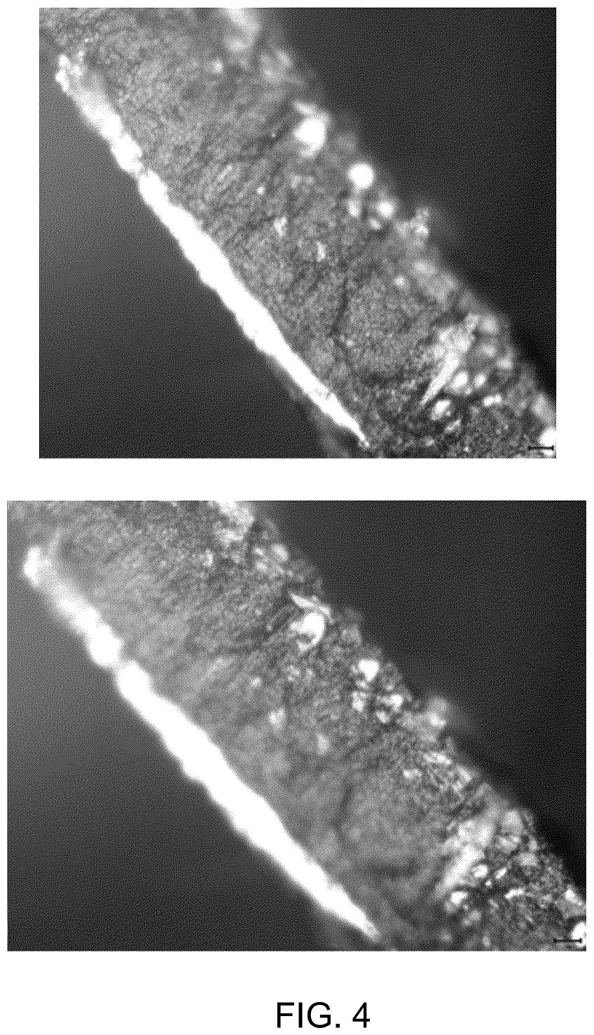

To confirm the location and morphology of the plated lithium, a lithium half-cell coin-cell was assembled. After a large initial charge (13 mAh), the coin cell was disassembled, cross-sectioned and imaged with an optical microscope (see FIG. 4). A liquid electrolyte coin cell was used for this experiment because it could be easily disassembled without damaging or obscuring the fully charged electrode. Furthermore, this experiment demonstrates the ability of the multi-layer current collector as described herein to operate in conventional cells utilizing carbonate based organic electrolytes. Three layers are clearly visible in the cross sectioned current collector. The best-defined layer is the 10 μm thick stainless steel current collector on bottom. On the top of the multi-layer current collector, the thin iridescent (˜5 μm) cPAN shield layer can be seen with the help of polarizing filters. The cPAN layer appears to be cracked along the edge of the cross section. This is likely due to the fact that the charged current collector was simply cut with scissors and is not a consequence of plating a large volume of Li-metal. Between the stainless steel and cPAN layers is a thick (˜50-60 μm), dense, homogeneous layer. Because the calculated thickness of the deposited Li should have been 56 μm, this layer represents almost perfectly dense plated lithium and Li—Ag alloy. This is further proof that not only is the cPAN shield layer capable of passing Li-ions on to the Ag seed layer below, but that the Ag seed layer is able to facilitate the deposition of thick, dense, dendrite free Li-layers (˜12 mAh) long after becoming fully saturated itself (˜1 mAh).

### Example 3

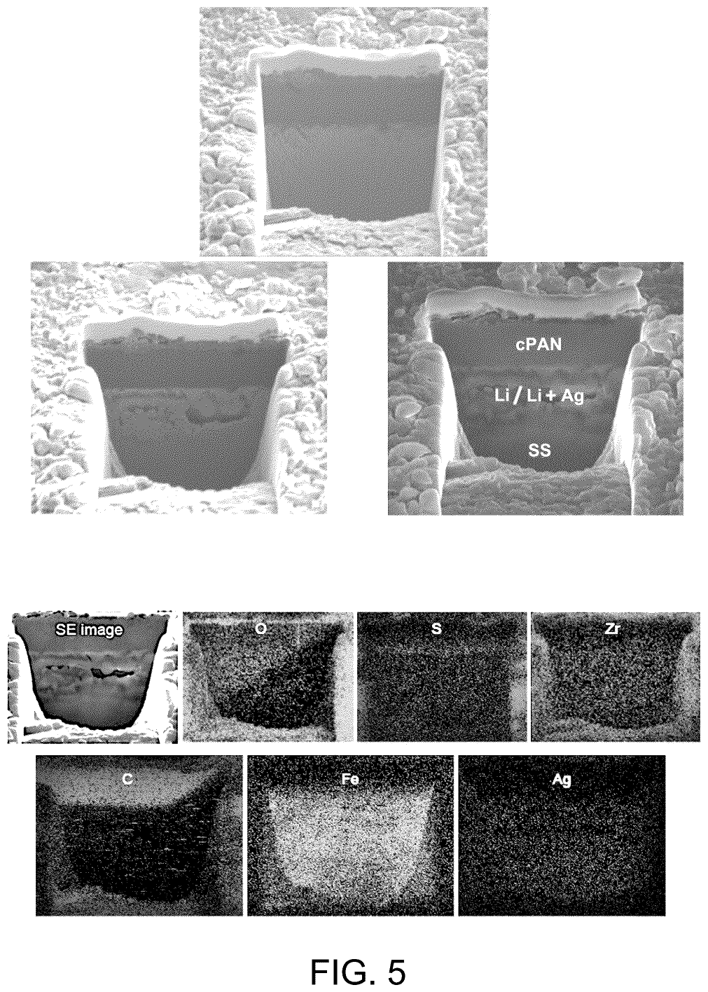

To further confirm the operating mechanism of the tri-layered current collector as described herein, an all-solid-state anodeless full-cell (vs NMC 811) was cross sectioned and imaged after prolonged cycling (see FIG. 5). A focused ion beam (FIB) mill and scanning electron microscope (SEM) were used to ensure a cleaner interface and a more detailed view into the charged current collector's structure. The SEM images of the cross sectioned electrode clearly show the dark ˜5 μm cPAN shield layer. This was confirmed by energy dispersive X-ray spectroscopy (EDS) mapping of the cross section. Notice that the cPAN layer remains fully intact with no observable cracking despite the cell being cycled over 50 times. This highlights the toughness of the shield layer and confirms that the cracking observed in FIG. 4 was likely due to the brute force cross sectioning method. The EDS maps show a strong, broad Fe signal. Interestingly, no signal corresponding to Ag could be identified (Li does not show up in EDS mapping). This is likely due to the dissolution of the Ag within the deposited Li to an extremely dilute concentration upon full charge. In the first FIB cross sectioned image, the plated Li layer is relatively dense and practically indistinguishable from the SS foil below. This agrees well with the cross sectional images collected with an optical microscope (FIG. 4).

Next, the FIB-milled trench was widened near the surface of the existing cross section in a polishing step. After this polishing step, a large degree of porosity and inhomogeneity is observed in the now easily identified Li/Li+Ag layer. This morphological change can be attributed to lithium metal's low density, melting point, thermal conductivity and shear modulus, all of which make it especially sensitive to techniques such as FIB-SEM imaging. In fact, previous literature documented very similar morphological changes in pristine Li-foils upon FIB cross sectioning under normal operating conditions. Therefore, it is not believed that the large degree of porosity and inhomogeneity observed in the Li/Li+Ag layer is due to flaws in the Ag seed layer or issues with non-uniform plating or stripping with cycling. Instead, it is suspected that all of these unexpected structural anomalies are FIB related and not representative of the true structure of the plated Li in this sample.

### Example 4

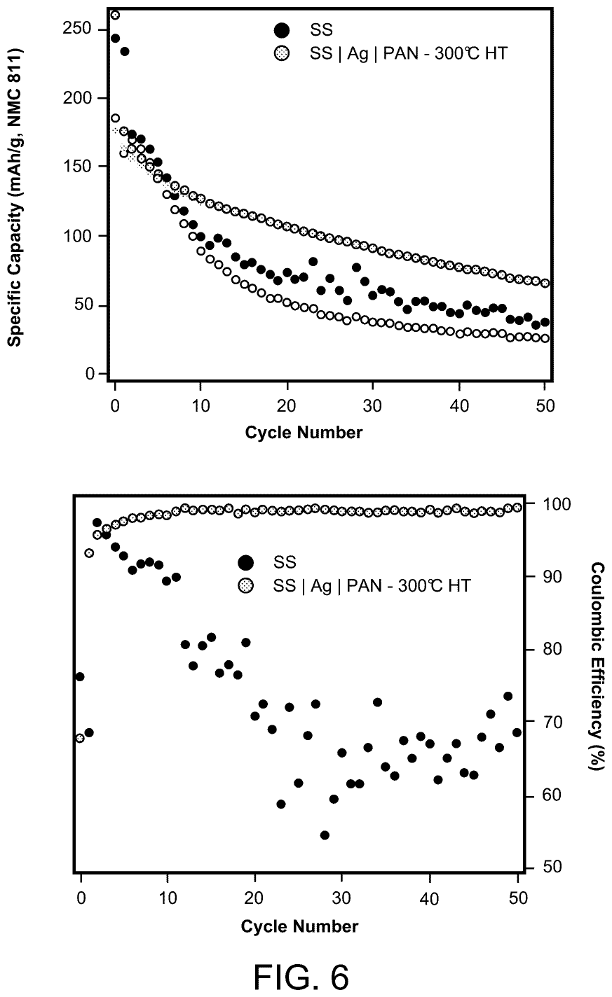

The tri-layered current collector was cycled in an all-solid-state full-cell and its performance was compared to a blank stainless steel current collector as a baseline (see FIG. 6). These all-solid-state full-cells were constructed with an argyrodite solid electrolyte and NMC 811 cathode active materials. The cells were cycled once at C/20, based on a 3 mAh cathode capacity, before long term cycling at C/10. A constant current protocol with no voltage holds was used to cycle the cells within a voltage window of 4.3-3.4 V. During cycling, the cells were kept at 60° C. in the inert atmosphere of a glove box.

Both cells achieved similar first cycle charge capacities, ˜250 mAh/g (normalized to mass of cathode active material). This value is larger than the theoretical maximum of the NMC 811 cathode material, with the extra capacity likely originating from irreversible side reactions occurring within the cathode composite as the NMC 811 used in this experiment contained no passivating coating and is expected to react with the argyrodite solid electrolyte. Interestingly, the first cycle coulombic efficiency of the bare stainless steel baseline cell is significantly larger than that of the multi-layered current collector which is only ˜70%. This could be due to incomplete delithiation of the Li—Ag alloy upon discharge or trapping of Li-ions within the cPAN shield layer. With continued cycling, the capacity of the multi-layered current collector gradually fades while its coulombic efficiency exceeds 99%. The SS baseline cell, on the other hand, experiences rapid capacity loss after the 5^{th} cycle.

While the gradual capacity degradation observed in the multi-layered current collector cell could be largely accounted for by losses and side reactions occurring in the unoptimized cathode, the rapid capacity loss and low coulombic efficiency of the SS baseline cell strongly suggest it experienced “soft short circuiting” and cell failure early on in the cycling test. This result shows that the multi-layered current collector can enable the long-term cycling of an anodeless full cell under conditions that led to rapid cell failure when just a stainless steel current collector was used. In other words, the dual use of an alloying (Ag) seed layer and a cPAN shield layer can in fact enable the reversible plating and stripping of dense Li-metal deposits while preventing rapid capacity loss and dendritic short circuiting experienced in their absence (SS baseline cell).

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/We claim:

1. An anodeless Li-metal cell, comprising:
a multi-layer current collector, comprising:
a current collector layer;
a lithium-alloying or lithium-soluble seed layer disposed on the current collector layer; and
a lithium ion-conductive protective layer disposed on the seed layer.

2. The anodeless Li-metal cell of claim 1, wherein the current collector layer is comprised of material that is unreactive with lithium.

3. The anodeless Li-metal cell of claim 1, wherein the current collector layer is a metal foil layer.

4. The anodeless Li-metal cell of claim 1, wherein the current collector is comprised of stainless steel foil.

5. The anodeless Li-metal cell of claim 1, wherein the material of the seed layer comprises Ag, Sn, In, Al, Ge, Bi, or any combination thereof.

6. The anodeless Li-metal cell of claim 1, wherein the material of the seed layer comprises Ag.

7. The anodeless Li-metal cell of claim 1, wherein the protective layer comprises linear polyacrylonitrile (PAN).

8. The anodeless Li-metal cell of claim 1, wherein the protective layer comprises cyclized polyacrylonitrile (cPAN).

9. The anodeless Li-metal cell of claim 1, wherein the protective layer comprises LiPON.

10. The anodeless Li-metal cell of claim 1, further comprising:
an electrolyte, wherein the electrolyte is shielded from the seed layer and the current collector layer by the protective layer.

11. The anodeless Li-metal cell of claim 10, wherein the electrolyte is an organic electrolyte.

12. The anodeless Li-metal cell of claim 10, wherein the electrolyte is an ionic liquid electrolyte.

13. The anodeless Li-metal cell of claim 10, wherein the electrolyte is a solid state electrolyte.

14. A method of cycling a Li-metal cell, comprising:
providing a Li-metal cell, the cell comprising:
a multi-layer current collector, comprising
a current collector layer;
a lithium-alloying or lithium-soluble seed layer disposed on the current collector layer; and
a lithium ion-conductive protective layer disposed on the seed layer; and
an electrolyte, wherein the electrolyte is shielded from the seed layer and the current collector layer by the protective layer; and
charging the Li-metal cell to thereby:
lithiate the seed layer; and
form a lithium metal layer between the lithiated seed layer and the protective layer.

15. The method of claim 13, further comprising:
discharging the Li-metal cell to thereby:
delithiate the seed layer; and
remove the lithium metal layer such that the protective layer is disposed on the seed layer.

16. The method of claim 14, wherein the current collector layer is comprised of material that is unreactive with lithium.

17. The method of claim 14, wherein the current collector layer is a metal foil layer.

18. The method of claim 14, wherein the current collector is comprised of stainless steel foil.

19. The method of claim 14, wherein the material of the seed layer comprises Ag, Sn, In, Al, Ge, Bi, or any combination thereof.

20. The method of claim 14, wherein the material of the seed layer comprises Ag.

21. The method of claim 14, wherein the protective layer comprises linear polyacrylonitrile (PAN).

22. The method of claim 14, wherein the protective layer comprises cyclized polyacrylonitrile (cPAN).

23. The method of claim 14, wherein the protective layer comprises LiPON.

24. The method of claim 14, wherein the electrolyte is an organic electrolyte.

25. The method of claim 14, wherein the electrolyte is an ionic liquid electrolyte.

26. The method of claim 14, wherein the electrolyte is a solid-state electrolyte.
